(19) United States
(12) Patent Application Publication
(10) Pub. No.: US 2010/0151304 A1
(43) Pub. Date: Jun. 17, 2010

(54) BATTERY COVER LATCHING ASSEMBLY

(75) Inventor: SHUI-JIN DONG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/564,163

(22) Filed: Sep. 22, 2009

(30) Foreign Application Priority Data
Dec. 11, 2008 (CN) 200810306190.4

(51) Int. Cl. H01M 2/10

(52) U.S. Cl. 429/97

(57) ABSTRACT

A battery cover latching assembly comprises a battery housing member, a battery cover and a button module. The battery housing member has a plurality of latching slots. The battery cover has a plurality of latching portions protruding therefrom corresponding to the latching slots. The button module includes an operating element and a rotating element, the operating element is mounted to the battery cover. The rotating element rotatably is mounted to the battery housing member. One end of the rotating element resists against the battery cover. Another end of the rotating element resists against the operating element. When the operating element is pressed toward the battery housing member, the operating element rotates the rotating element to push the battery cover away from the battery housing member, so as to detach the battery cover from the battery housing member.

### BACKGROUND

1. Technical Field

The exemplary disclosure generally relates to battery cover latching assemblies, particularly to a battery cover latching assemblies used in portable electronic devices.

2. Description of Related Art

As a power source, batteries are widely used in portable electronic devices, such as personal digital assistants (PDAs), cellular phones and etc. Conventional batteries are received in the electronic devices, and battery covers are designed to attach with housings of the electronic devices to package the batteries. When replacing or repairing the batteries, the battery cover has to be detached from the housing of the electronic devices.

A clasp structure or latch structure is used with a conventional battery cover to engage with a housing of a portable electronic device. For example, a latch comprises a pair of hooks at one end of the battery cover and a locking pin protruding from the other end of the battery cover. Accordingly, a pair of troughs is defined in an end portion of a backside of a housing of the electronic device, and a locking hole is defined in the other end portion of the backside of the housing. In assembly, the hooks are firstly inserted into the troughs in the backside of the housing. Then, the battery cover is pressed downwardly to the housing until the locking pin on the battery cover is inserted into the locking hole in the backside of the housing. The battery cover is thus assembled to the housing of the cellular phone. However, during disassembly, the battery cover is susceptible to being damaged, since a greater force is exerted thereon. As a result, it is inconvenient for a user to change a battery in the housing of the electronic device.

Therefore, there is a room for improved in the arts.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary battery cover latching assembly. Moreover, in the drawings like reference numerals designate corresponding parts throughout the several views. Wherever possible, the same reference numbers are used throughout the drawings to refer to the same or like elements of an embodiment.

FIG. 1 is an exploded view of an exemplary embodiment of a battery cover latching assembly including a battery housing member, a battery cover and a button module.

FIG. 2 is similar to FIG. 1, but showing the battery cover latching assembly in another aspect.

FIG. 3 is an assembled view of the battery cover latching assembly shown in FIG. 1.

FIG. 4 is a cross-sectional view of the battery cover latching assembly shown in FIG. 3.

### DETAILED DESCRIPTION OF THE EMBODIMENTS

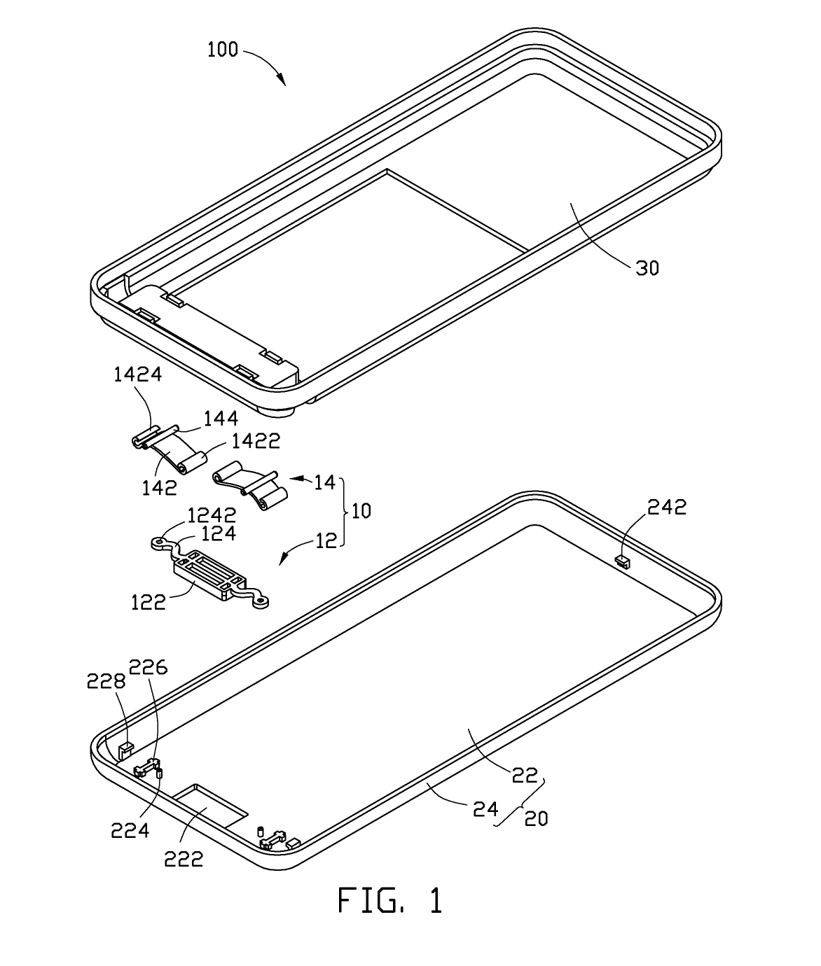

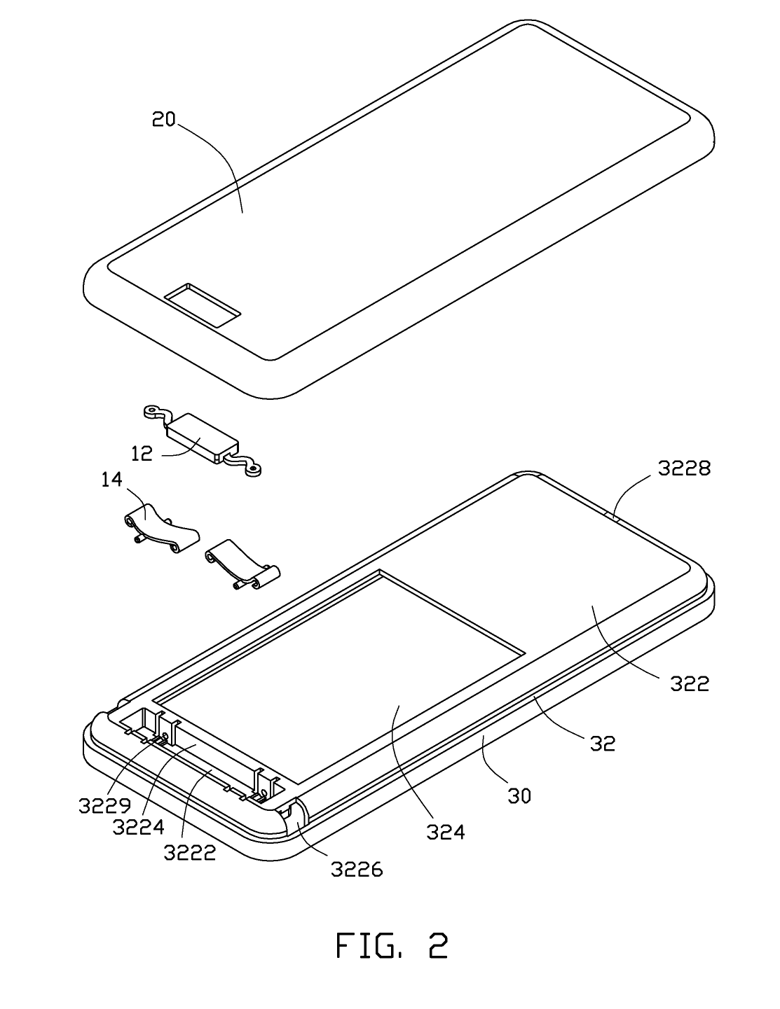

Referring to FIGS. 1 and 2, an exemplary battery cover latching assembly 100 used in a portable electronic device for accommodating a battery is shown. The battery cover latching assembly 100 includes a button module 10, a battery cover 20 and a battery housing member 30. The battery cover 20 is to be latched with the battery housing member 30. The button module 10 is mounted between the battery cover 20 and the battery housing member 30, and configured to release the latching engagement of the battery cover 20 and battery housing member 30.

The button module 10 includes an operating element 12 and two rotating elements 14. The operating element 12 includes a pressing portion 122 and two retaining portions 124 protruding outwardly from end portions of the pressing portion 122. Each retaining portion 124 is a bent arm. Each retaining portion 124 has a retaining hole 1242 defined in a distal end thereof mating with the battery cover 20.

Each rotating element 14 has an curved main body 142 and a shaft 144 attached to the main body 142. The main body 142 has a resisting portion 1422 curved inwardly at one end thereof and a pushing portion 1424 curved inwardly at another end thereof. The shaft 144 is transversely located at a tip portion of the main body 142. Two ends of the shaft 144 extend outwardly from opposite sidewalls of the main body 142, respectively.

The battery cover 20 includes a bottom wall 22 and a peripheral wall 24 protruding from an edge of the bottom wall 22. The battery cover 20 has a passage 222 defined through the bottom wall 22 adjacent to one end thereof. The passage 222 corresponds to the pressing portion 122 of the operating element 12, allowing the pressing portion 122 to be accommodated and exposed externally by the passage 222. The battery cover 20 further has two retaining poles 224 respectively protruding adjacent two sides of the passage 222. The retaining poles 224 respectively correspond to the retaining holes 1242 of the operating element 12. Moreover, the battery cover 20 has two buffers 226 respectively located at one side of each retaining pole 224 away from the passage 222. The buffers 226 respectively correspond to the pushing portions 1424 of the rotating elements 14 and are resilient and soft, such as elastic rubber. The buffers 226 provide touch sensation when a user presses the pressing portion 122. Additionally, the battery cover 20 has two latching portions 228 in the form of two hooks protruding from the bottom wall 22 respectively located at one side of each buffer. The latching portions 228 are configured to latch with the battery housing member 30. The battery cover 20 further has a securing portion 242 protruding from the peripheral wall 24 opposite to the passage 222. The securing portion 242 is also configured to latch with the battery housing member 30.

The battery housing member 30 has a concave portion 32 defined therein for accommodating the battery cover 20, so a bottom surface 322 is formed in the concave portion 32. The battery housing member 30 has a compartment 324 defined in the bottom surface 322 for accommodating a battery (not shown). The battery housing member 30 has a receiving groove 3222 defined in the bottom wall 322 corresponding to the passage 222 of the battery cover 20, so two inner sidewalls 3224 are formed in the receiving groove 3222. The receiving groove 3222 is configured to accommodate the rotating elements 14. The battery housing member 30 has two latching slots 3226 respectively defined besides two sides of the receiving groove 3222. The latching slots 3226 correspond to and latch with the latching portions 228 of the battery cover 20. The battery housing member 30 further has a securing slot 3228 defined in the bottom surface 322 corresponding to the securing portion 242 of the battery cover 20. The securing slot 3228 is configured to latch with the securing portion 242. Each inner sidewall 3224 has two shaft holes 3229 defined therein, and the shaft holes 3229 of one inner sidewall 3224 are coaxial to the shaft holes 3229 of the other inner sidewall 3224, correspondingly. The shaft holes 3229 are configured to respectively accommodate the shafts 144 of the button module 10.

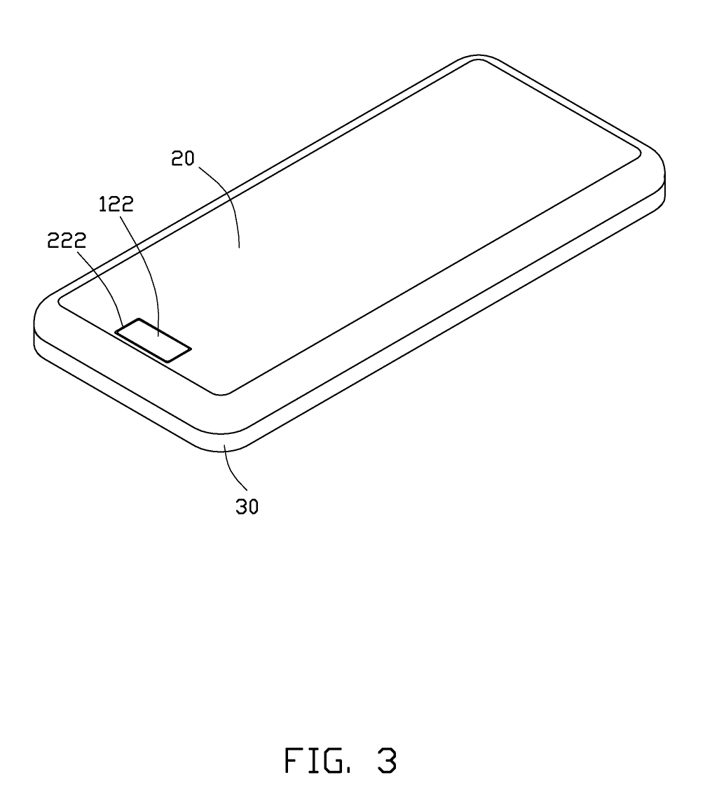

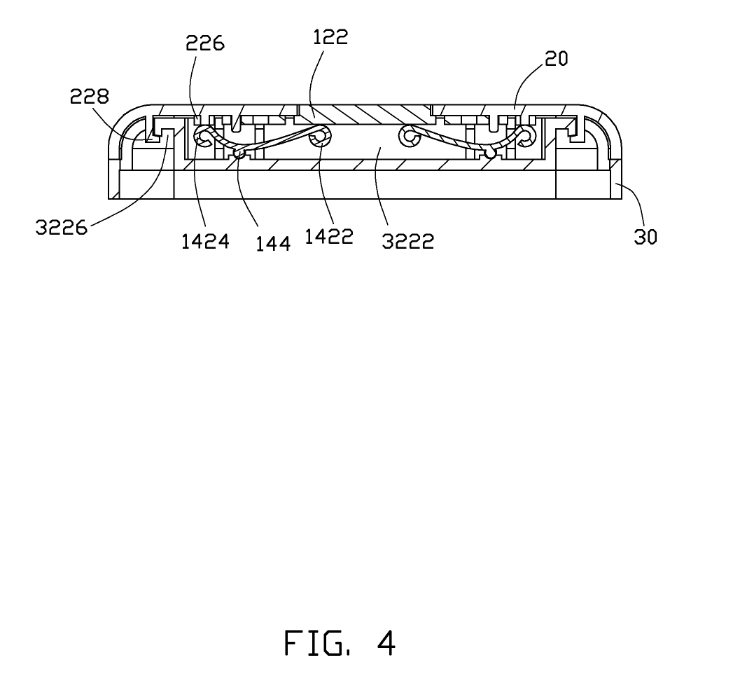

Referring to FIGS. 3 and 4, during assembling the battery cover latching assembly 100, firstly, the retaining holes 1242 of the operating element 12 are aligned with the retaining poles 224 of the battery cover 20. Secondly, the operating element 12 is pressed toward the battery cover 20 until the retaining poles 224 are accommodated in the retaining holes 1242. At this time, the pressing portion 122 of the operating element 12 is accommodated in the passage 222 and is exposed externally from the battery cover 20. Additionally, the retaining poles 224 may be tightly fixed by hot melt in the retaining holes 1242. Thirdly, one ends of the shafts 144 are respectively accommodated in the shaft holes 3229 of one inner sidewall 3224. Then, another ends of the shafts 144 are correspondingly slid toward the shaft holes 3229 of another inner sidewall 3224. At this time, the shafts 144 are deflected by another inner sidewall 3224. When another ends of shafts 144 are respectively aligned with the shaft holes 3229 of the other inner sidewall 3224, the shafts 144 are expanded and enter into the shaft holes 3229 of the other inner sidewall 3224. Thus, the shafts 144 are rotatably accommodated in the shaft holes 3229, i.e., the rotating elements 14 are rotatably accommodated in the receiving groove 3222. After that, the latching portions 228 of the battery cover 20 are latched, with the latching slots 3226 of the battery housing member 30 by snap-fit, and the securing portion 242 of the battery cover 20 is secured in the securing slot 3228 of the battery housing member 30, so the battery cover 20 is mounted to the battery housing member 30. At this stage, the resisting portions 1422 of the rotating elements 14 are resisted against the pressing portion 122 of the operating element 12, the pushing portion 1424 of the rotating elements 14 are resisted against the buffers 226 of the battery cover 20.

When detaching the battery cover 20 from the battery housing member 30, the pressing portion 122 of the operating element 12 is pressed to push the resisting portions 1422 of the rotating elements 14 toward the battery housing member 30, so as to rotate the rotating elements 14 about the shaft 144. Thereby, the pushing portions 1424 are moved away from the battery housing member 30 to push the battery cover 20 away from the battery housing member 30. When the latching portions 228 and the securing portion 242 are respectively released from the latching slots 3226 and the securing slot 3228, the battery cover 20 is released from the battery housing member 30.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latching assembly, comprising:
a battery housing member, the battery housing member having a plurality of latching slots;
a battery cover, the battery cover having a plurality of latching portion protruding therefrom and corresponding to the latching slots to latch the battery housing member with the battery cover; and
a button module, the button module including an operating element and a rotating element, the operating element mounted to the battery cover, the rotating element rotatably mounted to the battery housing member, one end of the rotating element resisting against the battery cover, another end of the rotating element resisting against the operating element;
wherein when the operating element is pressed toward the battery housing member, the operating element rotates the rotating element to push the battery cover away from the battery housing member, so as to detach the battery cover from the battery housing member.

2. The battery cover latching assembly as claimed in claim 1, wherein the rotating element includes an curved main body, the main body has a resisting portion formed at one end thereof and a pushing portion formed at another end thereof, the resisting portion resists against the operating element, the pushing portion resists against the battery cover.

3. The battery cover latching assembly as claimed in claim 2, wherein the rotating element further includes a shaft transversely mounted to the main body, and two ends of the shaft extend outwardly from two opposite sidewalls of the main body, respectively, the shaft is rotatabaly mounted to the battery housing member to rotatably mount the rotating element to the battery housing member.

4. The battery cover latching assembly as claimed in claim 3, wherein the shaft is located at a tip portion of the main body.

5. The battery cover latching assembly as claimed in claim 3, wherein the battery housing member has a receiving groove defined therein, the rotating element is accommodated in the receiving groove, and two inner sidewalls are formed in the receiving groove, each inner sidewall has a shaft hole defined therein, the two ends of the shaft are rotatably accommodated in the shaft holes, respectively.

6. The battery cover latching assembly as claimed in claim 2, wherein the operating element includes a pressing portion, the pressing portion resists the resisting portion of the rotating element.

7. The battery cover latching assembly as claimed in claim 6, wherein the operating element has two retaining portion respectively protruding from two opposite ends of the pressing portion, each retaining portion has a retaining hole defined therethrough, the battery cover has two retaining poles protruding therefrom corresponding to the retaining hole, the retaining poles are respectively accommodated in the retaining holes.

8. The battery cover latching assembly as claimed in claim 7, wherein the battery cover has a passage defined therethrough corresponding to the pressing portion, the pressing portion is accommodated in and exposed externally by the passage.

9. The battery cover latching assembly as claimed in claim 8, wherein the two retaining poles respectively located besides two sides of the passage.

10. The battery cover latching assembly as claimed in claim 9, wherein the battery cover further has a buffer located at one side of each retaining pole away from the passage, the buffers aligned with the pushing portions of the rotating elements.

11. A battery cover latching assembly, comprising:
a battery housing member, the battery housing member having a plurality of latching slots;
a battery cover, the battery cover having a plurality of latching portion protruding therefrom corresponding to the latching slots and latched with the latching slots; and
a button module, the button module including an operating element and two rotating elements, the operating element mounted to the battery cover, the rotating elements rotatably mounted to the battery housing member, one end of each rotating element resisting against the battery cover, another end of each rotating element resisting against the operating element;
wherein when the operating element rotates the rotating elements, the rotating elements push the battery cover away from the battery housing member, so as to detach the battery cover from the battery housing member.

12. The battery cover latching assembly as claimed in claim 11, wherein each rotating element includes an curved main body, the main body has a resisting portion formed at one end thereof and a pushing portion formed at another end thereof, the resisting portion resists against the operating element, the pushing portion resists against the battery cover.

13. The battery cover latching assembly as claimed in claim 12, wherein each rotating element further includes a shaft transversely mounted to corresponding main body, and two ends of each shaft extend outwardly from two opposite sidewalls of corresponding main body, correspondingly.

14. The battery cover latching assembly as claimed in claim 13, wherein the shafts are respectively located at a tip portion of each main body.

15. The battery cover latching assembly as claimed in claim 13, wherein the shafts are rotatabaly mounted to the battery housing member to rotatably mount the rotating elements to the battery housing member.

16. The battery cover latching assembly as claimed in claim 15, wherein the battery housing member has a receiving groove defined therein, the rotating elements are accommodated in the receiving groove, and two inner sidewalls are formed in the receiving groove, each inner sidewall has two shaft holes defined therein, the two ends of each shaft are rotatably accommodated in the shaft holes, correspondingly.

17. The battery cover latching assembly as claimed in claim 11, wherein the operating includes a pressing portion and two retaining portion respectively protruding from two opposite ends of the pressing portion, the pressing portion resists the resisting portions of the rotating elements, each retaining portion has a retaining hole defined therethrough, the battery cover has two retaining poles protruding therefrom corresponding to the retaining hole, the retaining poles are respectively accommodated in the retaining holes.

18. The battery cover latching assembly as claimed in claim 17, wherein the battery cover has a passage defined therethrough corresponding to the pressing portion, the pressing portion is accommodated in and exposed externally by the passage.

19. The battery cover latching assembly as claimed in claim 18, wherein the two retaining poles respectively located besides two sides of the passage.

20. The battery cover latching assembly as claimed in claim 19, wherein the battery cover further has two buffers located at two sides of the passage, the buffers correspond to the pushing portions of the rotating elements.
